(19) United States
(12) Patent Application Publication
(10) Pub. No.: US 2021/0149865 A1
(43) Pub. Date: May 20, 2021

(54) SEAMLESSLY MIGRATING DATA AND INDEX IN DISTRIBUTED NoSQL DATABASE SYSTEMS

(71) Applicant: International Business Machines Corporation, Armonk, NY (US)

(72) Inventors: Huan Wu, Beijing (CN); Hui Liu, Beijing (CN); Rui Nie, Beijing (CN); Peng Hui Jiang, Beijing (CN)

(21) Appl. No.: 16/686,527

(22) Filed: Nov. 18, 2019

(51) Int. Cl. G06F 16/22; G06F 16/21; G06F 16/23

(52) U.S. Cl. CPC G06F 16/2272; G06F 16/2365; G06F 16/221; G06F 16/214

(57) ABSTRACT

In an approach to seamlessly migrating data and index in distributed database systems, when a data migration request is received, a source data and a source index are migrated from a source cluster to a target cluster. When new data is received from a client to be written to the source data during the data migration, a delta data and a delta index are stored to a portable data storage, where the delta data is the new data from the client, and the delta index is created from the delta data. When the data migration from the source cluster to the target cluster is complete, the delta data and the delta index are migrated from the portable data storage to the target cluster.

### BACKGROUND

The present invention relates generally to the field of database migration support, and more particularly to seamlessly migrating data and index in distributed database systems.

The rapid growth of data generation has been fueled by many factors, including the rapid growth of social media. User-driven content has grown rapidly and has increased the volume and type of data that is produced, managed, analyzed, and archived. In addition, new sources of data, such as Internet of Things (IoT) sensors, automated trackers, and other monitoring systems generate huge volumes of data on a regular basis. These large volumes of data sets have introduced new challenges for data storage, management, analysis, and archiving. In addition, data is becoming increasingly semi-structured and sparse. To resolve the problems related to large-volume and semi-structured data, a class of new database products has emerged. These new classes of database products consist of column-based data stores, key/value pair databases, and document databases. Together, these databases are called “not only SQL”, or NoSQL. NoSQL plays a vital role in an enterprise application which needs to access and analyze a massive set of data that is being made available on multiple virtual servers in the cloud infrastructure and mainly when the data set is not structured.

### SUMMARY

Embodiments of the present invention disclose a method, a computer program product, and a system for seamlessly migrating data and index in distributed database systems. In one embodiment, when a data migration request is received, a source data and a source index are migrated from a source cluster to a target cluster. When new data is received from a client to be written to the source data during the data migration, a delta data and a delta index are stored to a portable data storage, where the delta data is the new data from the client, and the delta index is created from the delta data. When the data migration from the source cluster to the target cluster is complete, the delta data and the delta index are migrated from the portable data storage to the target cluster.

### BRIEF DESCRIPTION OF THE DRAWINGS

FIG. 1 is a functional block diagram illustrating a distributed data processing environment, in accordance with an embodiment of the present invention.

FIG. 2a illustrates the operation of the database system, before the start of the migration from the source cluster to the target cluster, in accordance with an embodiment of the present invention.

FIG. 2b illustrates the first step of the migration from the source cluster to the target cluster, in accordance with an embodiment of the present invention.

FIG. 2c illustrates the second step of the migration from the source cluster to the target cluster, in accordance with an embodiment of the present invention.

FIG. 2d illustrates the third step of the migration from the source cluster to the target cluster, in accordance with an embodiment of the present invention.

FIG. 2e illustrates the fourth step of the migration from the source cluster to the target cluster, in accordance with an embodiment of the present invention.

FIG. 2f illustrates the final step of the migration from the source cluster to the target cluster, in accordance with an embodiment of the present invention.

FIG. 3 is a flowchart depicting operational steps of the migration program, on a computing device within the distributed data processing environment of FIG. 1, for seamlessly migrating data and index in distributed NoSQL database systems, in accordance with an embodiment of the present invention.

FIG. 4 depicts a block diagram of components of the computing devices executing the migration program within the distributed data processing environment of FIG. 1, in accordance with an embodiment of the present invention.

### DETAILED DESCRIPTION

For many years, the software industry typically used relational database management systems to store and manage persistent data. A relational database is a set of formally described tables from which data can be accessed or reassembled in many different ways without having to reorganize the database tables. Relational database systems establish a well-defined relationship between these database tables. The standard interface of a relational database is the Structured Query Language, or SQL. Not only SQL, or NoSQL, is a new set of a database that has emerged in the recent past as an alternative solution to relational databases.

NoSQL is commonly used to refer to all databases and data stores that are not based on the relational database management systems principles. It relates to large data sets accessed and manipulated on a wide scale. NoSQL does not represent a single product or technology, but represents a group of products and various related data concepts for storage and management.

Database clustering is the process of combining more than one server or instance (a set of memory structures that manage database files) connecting a single database. When one server may not be adequate to manage the amount of data or the number of requests, a data cluster is implemented.

Often, large databases or database clusters are partitioned into smaller, faster and easily manageable databases called shards. The database clusters may be composed of any number of shards. NoSQL databases generally use shards by default; no additional steps are required. The NoSQL database automatically spreads the data across servers, using whichever server is available to fetch the data in the least amount of time, while maintaining the integrity of the data.

For distributed NoSQL database systems, several nodes to hundreds of nodes constitute a cluster to provide data service. The data stored in these nodes are divided into different shards and multiple copies of each record are stored. It is often desirable to migrate data from one cluster to another, for example, when disk usage is high on a cluster, the client requests to move its account to its newly provisioned cluster, or to reduce the impact to important clients when a cluster experiences poor performance.

When migration is being performed, it is common that the client keeps writing to the databases. Since there are hundreds of databases that need to be migrated, the data that is written after the data migration completes, but before the pointer is switched to the new cluster, needs additional time to migrate. During this period, there may be data inconsistency issues. The worst case is that there may be data loss if part of the delta data, the new data being written during the migration, is lost before migration completes. In existing systems, to keep data consistency, the client needs to wait for this delta data to be migrated before sending the new request, and this may cause downtime.

In existing systems, when the migration is executed, usually only the data is migrated, not the index. The system then needs additional time to rebuild the index once the data is migrated to the new cluster. This can cause poor performance in the cluster during the migration, and may even lead to a failure of a query to that cluster. Embodiments of the present invention seamlessly migrate both the data and the indices simultaneously in distributed NoSQL database systems, eliminating the need to rebuild the indices when the migration is complete, thereby avoiding the poor performance and query failures inherent in current technology.

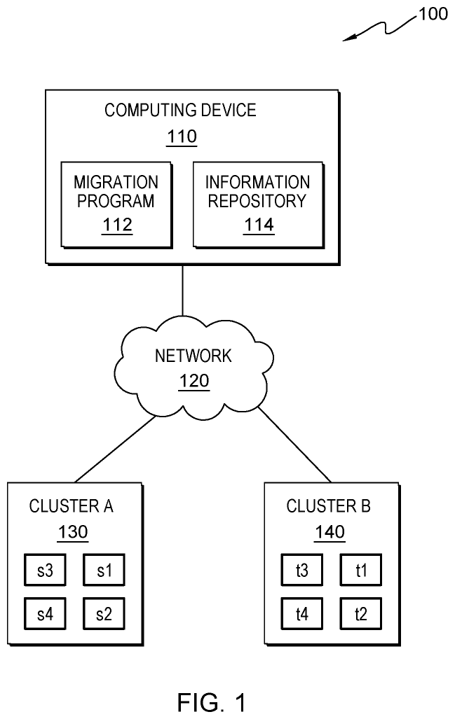

FIG. 1 is a functional block diagram illustrating a distributed data processing environment, generally designated 100, suitable for operation of migration program 112 in accordance with at least one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110, cluster A 130, and cluster B 140, all connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between computing device 110, cluster A 130, cluster B 140, and other computing devices (not shown) within distributed data processing environment 100.

Computing device 110 can be a standalone computing device, a management server, a web server, a mobile computing device, or any other electronic device or computing system capable of receiving, sending, and processing data. In an embodiment, computing device 110 can be a laptop computer, a tablet computer, a netbook computer, a personal computer (PC), a desktop computer, a personal digital assistant (PDA), a smart phone, or any programmable electronic device capable of communicating with other computing devices (not shown) within distributed data processing environment 100 via network 120. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers, etc.) that act as a single pool of seamless resources when accessed within distributed data processing environment 100.

In an embodiment, computing device 110 includes migration program 112. In an embodiment, migration program 112 is a program, application, or subprogram of a larger program for seamlessly migrating data and index in distributed NoSQL database systems. In an alternative embodiment, migration program 112 may be located on any other device accessible by computing device 110 via network 120.

In an embodiment, computing device 110 includes information repository 114. In an embodiment, information repository 114 may be managed by migration program 112. In an alternate embodiment, information repository 114 may be managed by the operating system of the device, alone, or together with, migration program 112. Information repository 114 is a data repository that can store, gather, compare, and/or combine information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, client data, configuration data, and other data that is received by migration program 112 from one or more sources, and data that is created by migration program 112.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, a NoSQL database, an object-oriented database, or one or more tables.

Cluster A 130 and cluster B 140 represent database clusters. In an embodiment, cluster A 130 and cluster B 140 can each combine any number of database servers or instances connecting a single database, and capable of communicating with computing device 110 within distributed data processing environment 100 via network 120. In an embodiment, data processing environment 100 contains cluster A 130 and cluster B 140. In another embodiment, data processing environment 100 may contain any number of clusters. In an embodiment, cluster A 130 contains shards s1, s2, s3, and s4, while cluster B 140 contains shards t1, t2, t3, and t4. In another embodiment, cluster A 130 and cluster B 140 may each contain any number of shards.

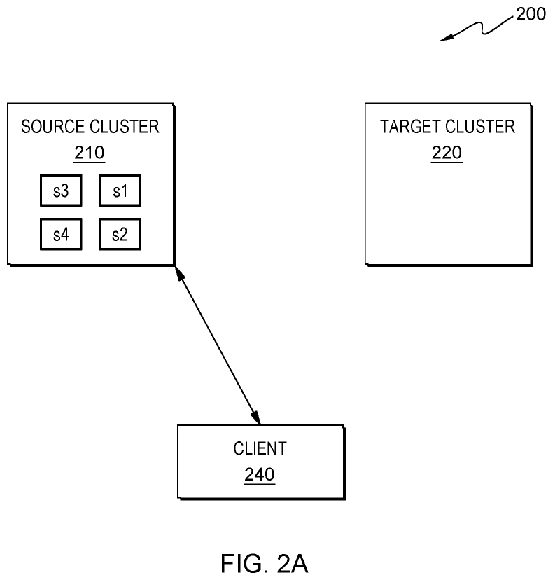

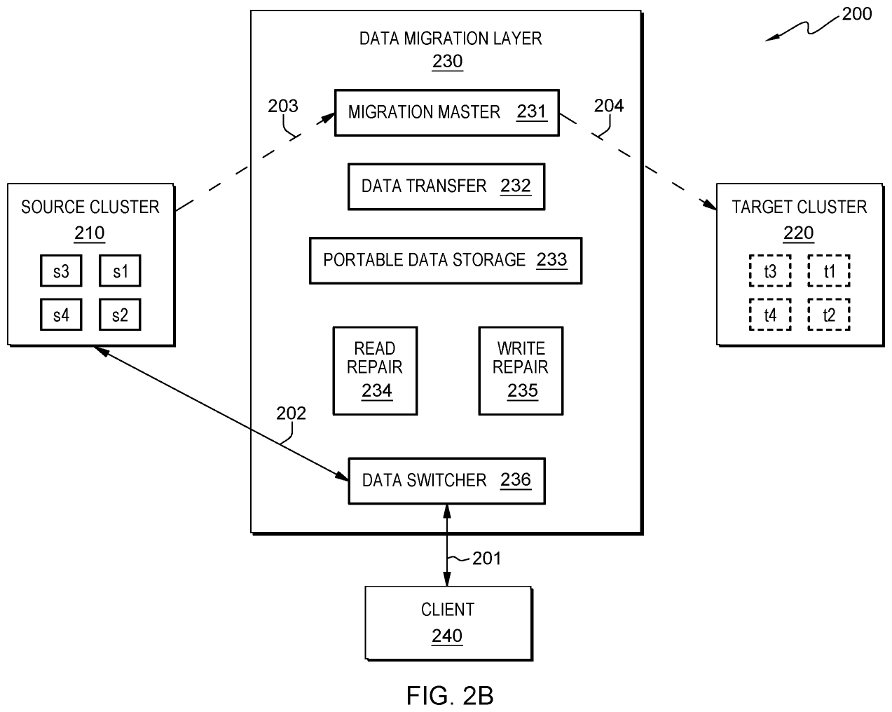

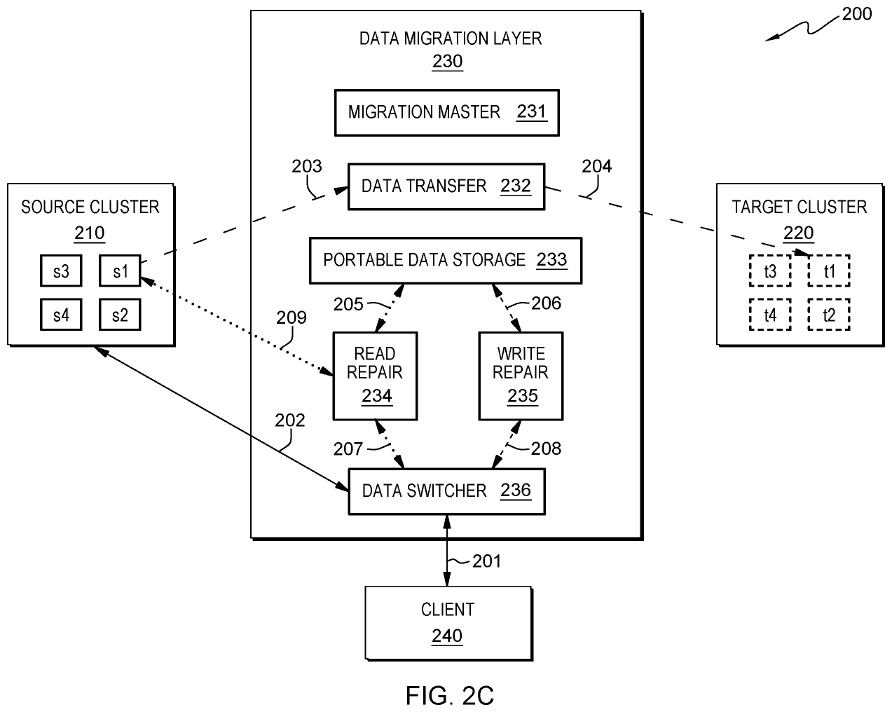

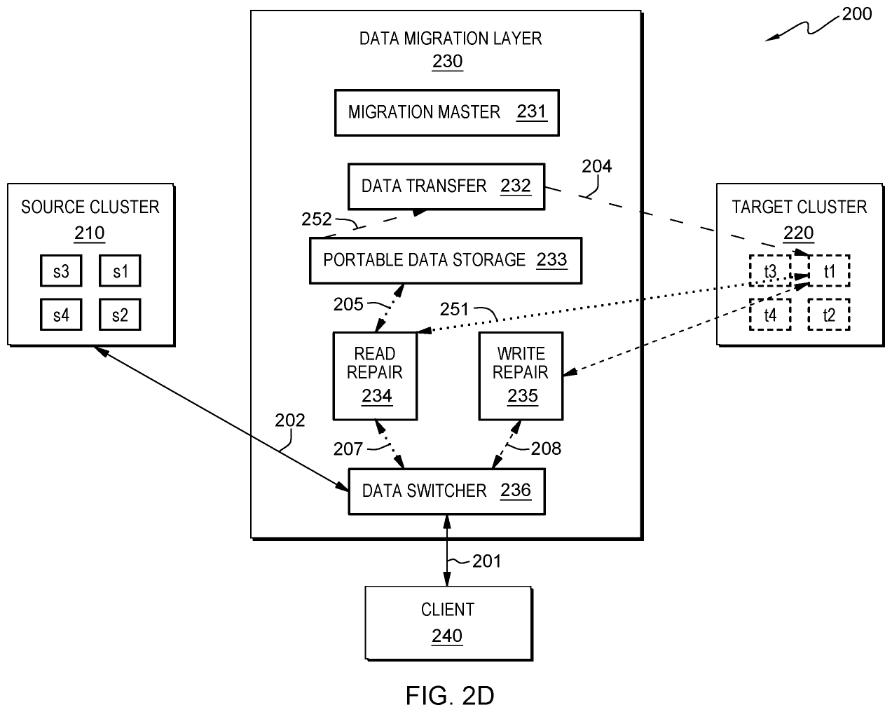

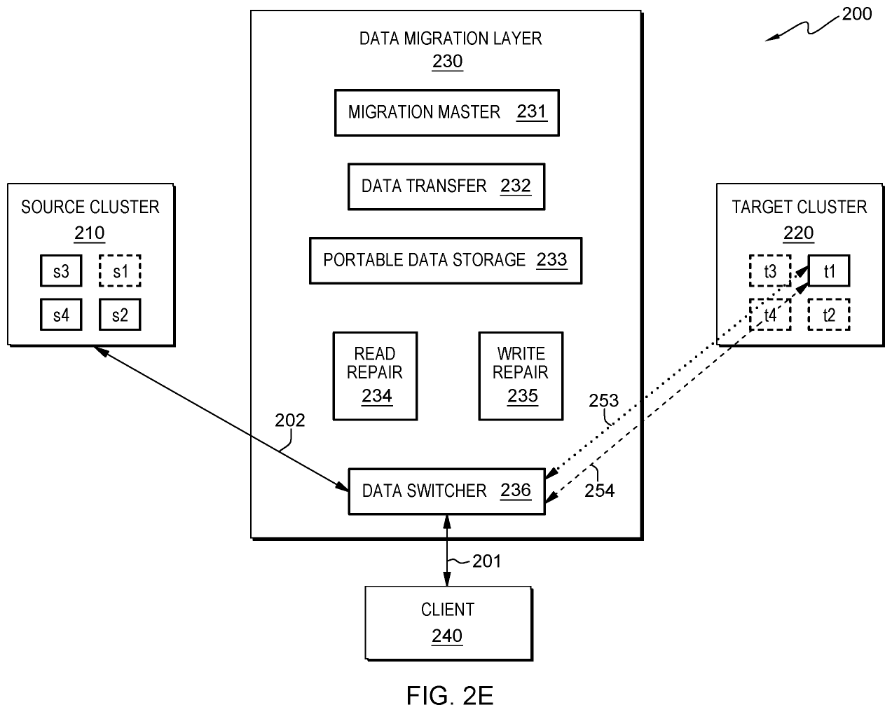

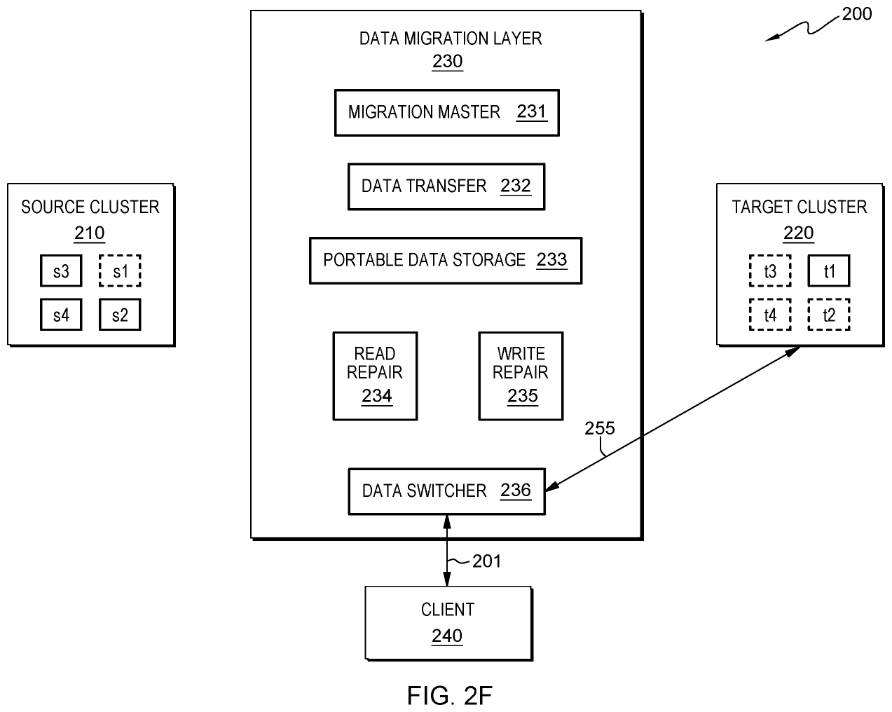

FIGS. 2a through 2f are illustrations of the steps to migrate the data from the source cluster to the target cluster in the database system, generally designated 200. It should be noted that these figures are provided for illustrative purposes only. Many modifications and variations will be apparent to those of ordinary skill in the art without departing from the scope and spirit of the invention. The steps illustrated in FIGS. 2a through 2f are described below.

FIGS. 2b through 2f include data migration layer 230. In an embodiment, migration program 112 creates data migration layer 230 to perform the seamless migration of the source data and source index from the source cluster to the target cluster. In the embodiment illustrated in FIGS. 2b through 2f, data migration layer 230 consists of the following components: migration master 231; data transfer 232; portable data storage 233; read repair 234; write repair 235; and data switcher 236.

In the embodiment illustrated in FIGS. 2b through 2f, migration master 231 initializes the target, by mapping the configuration from the source cluster to the target cluster, and controls the entire migration process.

In the embodiment illustrated in FIGS. 2b through 2f, portable data storage 233 stores the incoming stream (i.e., the delta data) during the migration.

In the embodiment illustrated in FIGS. 2b through 2f, data transfer 232 transfers the data and the indices from both the source shard and portable data storage 233 to the target shard.

In the embodiment illustrated in FIGS. 2b through 2f, if the incoming read requests involve the data stored in portable data storage 233, read repair 234 will combine the delta data and delta index in portable data storage 233 with the source data and source index on the source shard, or the target data and target index on the target shard, depending on where the latest data is stored at the particular point in the migration, and return the latest version of the data and index to client 240.

In the embodiment illustrated in FIGS. 2b through 2f, write repair 235 writes the updated data into portable data storage 233 before the source data is migrated to the target. When the migration of the data from the source shard (for example, shard s1 in FIG. 1) to the target shard is complete, write repair 235 writes the delta data from portable data storage 233 into the target shard (for example, shard t1 in FIG. 1). If write requests are received from a client while transfer of the updated data from portable data storage 233 to the target shard is still ongoing, then write repair 235 writes the updated data from the client directly into the target shard. Here, the delta data is the data that has been previously written into portable data storage 233 and is then transferred to the target shard. The updated data is the data from the client that is written directly into the target shard once the migration from the source shard to the target shard is complete, even though the delta data is still being written into the target shard by data transfer 232.

In the embodiment illustrated in FIGS. 2b through 2f, data switcher 236 redirects incoming read/write requests to different components based on the migration activities. If a request is targeted at a data shard that is currently being migrated, data switcher 236 redirects the client request to read repair 234, if the client request is a read operation, or write repair 235, if the client request is a write operation. If the request is targeted at shards which are not currently being migrated, then data switcher 236 redirects the request to the appropriate shards directly.

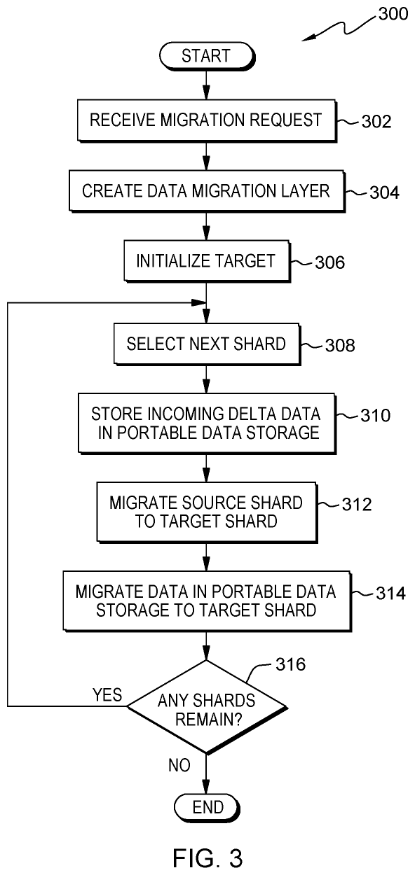

FIG. 3 is a flow chart diagram of workflow 300 depicting operational steps for migration program 112 for seamlessly migrating data and index in distributed NoSQL database systems in accordance with at least one embodiment of the invention. In an alternative embodiment, the steps of workflow 300 may be performed by any other program while working with migration program 112. In an embodiment, migration program 112 receives a data migration request. In an embodiment, migration program 112 creates a data migration layer. In an embodiment, migration program 112 initializes the target. In an embodiment, migration program 112 selects the next shard. In an embodiment, migration program 112 stores the incoming delta data in the portable data storage. In an embodiment, migration program 112 migrates the source shard to the target shard. In an embodiment, migration program 112 migrates the data in the portable data storage to the target shard.

The steps of workflow 300 are illustrated in FIGS. 2a through 2f, as described above. It should be noted that the configuration of source cluster A 130, target cluster B 140, and the description of FIGS. 2a through 2f, are just one example of one embodiment of workflow 300. The number of clusters and the number of shards in each cluster in FIGS. 2a though 2f and FIG. 1 are shown for illustrative purposes only, to clarify the steps of workflow 300. In other embodiments, source cluster A 130 and target cluster B 140 can each have any number of shards in workflow 300.

It should be appreciated that embodiments of the present invention provide at least for seamlessly migrating the data and the index from a source cluster to a target cluster in a distributed NoSQL database system. However, FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

Migration program 112 receives migration request (step 302). At step 302, migration program 112 receives a request to migrate a NoSQL database from a source cluster to a target cluster. In an embodiment, the data migration request may come from a user of the NoSQL database. In another embodiment, the data migration request may come from a client, for example, to migrate the database to a new installation. Step 302 is illustrated in FIG. 2a.

Migration program 112 creates data migration layer (step 304). At step 304, migration program 112 creates data migration layer 230, including migration master 231, data transfer 232, portable data storage 233, read repair 234 and write repair 235, and data switcher 236. In an embodiment, data migration layer 230 ensures that both consistency and availability are maintained when migrating a distributed NoSQL database cluster.

In an embodiment, migration program 112 creates the data migration layer on computing device 110. In another embodiment, migration program 112 creates the data migration layer on another device that is accessible to migration program 112 over network 120.

Migration program 112 initializes target (step 306). In an embodiment, migration program 112 initializes the target cluster B 140 according to the configuration and status of the source shards in source cluster A 130 by allocating shards (for example, shards t1 through t4 in FIGS. 2b-2f) in the target cluster (for example, target cluster 220 in FIGS. 2b-2f), which correspond with the shards (for example, shard s1 through s4 in FIGS. 2a-2f) in the source cluster (for example, source cluster 210 in FIGS. 2a-2f). In an embodiment, migration program 112 ensures that the target is ready to accept data before proceeding to step 308. Step 306 is illustrated in FIG. 2b. In FIG. 2b, migration master 231 receives the configuration data from source cluster 210, as shown by arrow 203. Migration master 231 writes the configuration data from source cluster 210 to target cluster 220, as shown by arrow 204.

Migration program 112 selects next shard (step 308). In step 308, migration program 112 selects the next shard in source cluster A 130. In an embodiment, migration program 112 selects the next shard in source cluster A 130 based on the numbering of the shards. In another embodiment, migration program 112 selects the next shard in source cluster A 130 based on any algorithm appropriate to select the order of migration of the shards in the cluster.

Migration program 112 stores incoming delta data in portable data storage (step 310). At step 310, if migration program 112 determines that there are incoming write requests (arrow 207 in FIGS. 2b through 2e) targeting the source shard (s1 in this example) during the migration, then migration program 112 will use data switcher 236 to redirect the delta data intended for the source shard (s1 in this example) to write repair 235, and then write the updated data to the portable data storage. In the example case shown in FIGS. 2a-f, the write data transfers intended for active shard s1 will be redirected by data switcher 236 to portable data storage 233 (arrow 252 in FIG. 2d). Step 310 is illustrated in FIG. 2c. In FIG. 2c, arrows 207 and 208 illustrate data switcher 236 redirecting the incoming client data to read repair 234 and write repair 235, respectively, as described above. FIG. 2c also illustrates read repair 234 and write repair 235 transferring data to portable data storage 233 via arrows 205 and 206 respectively.

Migration program 112 migrates source shard to target shard (step 312). At step 312, migration program 112 uses data transfer 232 to transfer data from the source shard (s1 in this example) to the target shard (t1 in this example). Migration program 112 transfers both the source data and the source index to the target. If incoming write requests target the source shard (s1 in this example) during the migration, the write requests will be redirected by data switcher 236 to write repair 235. Write repair 235 stores the updated data in the portable data storage. If incoming read requests target the source shard (s1 in this example) during the migration, the read requests will be redirected by data switcher 236 to read repair 234. Read repair 234 combines the source data (from s1 in this example) and the updated data from the portable data storage to return the latest version of the data to the client. Step 312 is also illustrated in FIG. 2c. In FIG. 2c illustrates data transfer 232 transferring data from source cluster 210, via arrow 203, to target cluster 220, via arrow 204. FIG. 2c also illustrates that for incoming client requests, read repair 234 determines where the latest data resides during the migration. If the latest data is still in the source cluster, then read repair 234 will fetch the data from the source cluster, as illustrated by arrow 209.

Migration program 112 migrates data in portable data storage to target shard (step 314). At step 314, migration program 112 uses data transfer 232 to transfer data from portable data storage 233 to the target shard (t1 in the example). Migration program 112 transfers both the source data and the source index to the target. If there are incoming read requests targeting the source shard (s1 in this example) during this migration period, migration program 112 will redirect the read requests to read repair 234 (arrow 207 in FIG. 2d), and read repair 234 then combines the updated delta data from portable data storage 233 (illustrated by arrow 205 in FIG. 2d) and the target data from the target shard (t1 in this example, illustrated by arrow 251 in FIG. 2d) to return the latest version of the data to the client (arrow 201 in FIG. 2d). If there are incoming write requests targeting the source shard (s1 in this example) during this migration period, migration program 112 will redirect the write requests to write repair 235 (illustrated by arrow 208 in FIG. 2d) to identify where the latest version of the data is located. If the latest version of the data has already been migrated to the target shard, migration program 112 will update the data in target shard directly (illustrated by arrow 253 for reads and arrow 254 for writes in FIG. 2e). If the latest version of the data is located in the portable data storage, then migration program 112 gives priority to transfer this data from the portable data storage to the target shard, and then write repair 235 will update the data in the target shard (illustrated by arrow 255 in FIG. 2f).

Migration program 112 determines if any shards remain (step 316). At step 316, if migration program 112 determines that any source shards have not been migrated, then migration program 112 returns to step 308 to select the next shard to be migrated. If migration program 112 determines that no shards remain to be migrated, then migration program 112 ends. At this point, all incoming requests will be directed to the target cluster.

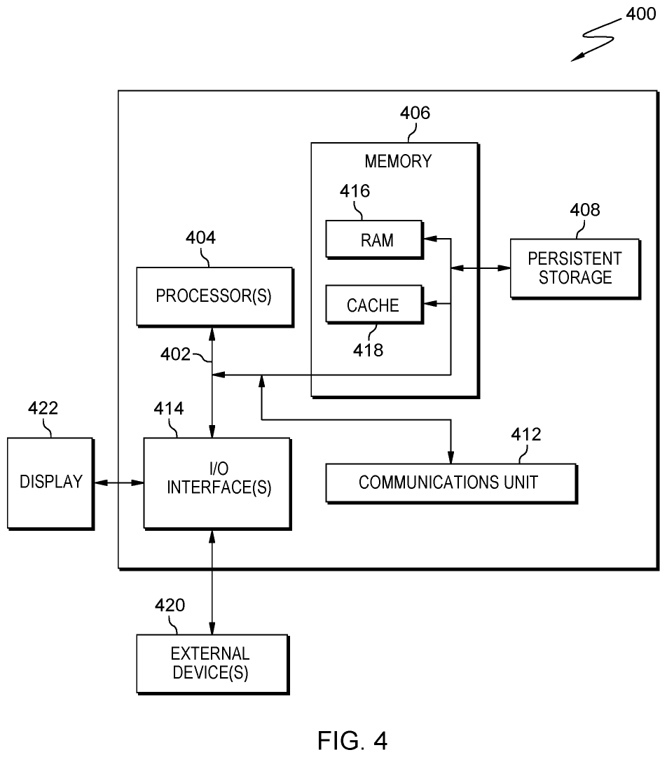

FIG. 4 is a block diagram depicting components of computing device 110 suitable for migration program 112, in accordance with at least one embodiment of the invention. FIG. 4 displays the computer 400, one or more processor(s) 404 (including one or more computer processors), a communications fabric 402, a memory 406 including, a random-access memory (RAM) 416, and a cache 418, a persistent storage 408, a communications unit 412, I/O interfaces 414, a display 422, and external devices 420. It should be appreciated that FIG. 4 provides only an illustration of one embodiment and does not imply any limitations with regard to the environments in which different embodiments may be implemented. Many modifications to the depicted environment may be made.

As depicted, the computer 400 operates over the communications fabric 402, which provides communications between the computer processor(s) 404, memory 406, persistent storage 408, communications unit 412, and input/output (I/O) interface(s) 414. The communications fabric 402 may be implemented with an architecture suitable for passing data or control information between the processors 404 (e.g., microprocessors, communications processors, and network processors), the memory 406, the external devices 420, and any other hardware components within a system. For example, the communications fabric 402 may be implemented with one or more buses.

The memory 406 and persistent storage 408 are computer readable storage media. In the depicted embodiment, the memory 406 comprises a RAM 416 and a cache 418. In general, the memory 406 can include any suitable volatile or non-volatile computer readable storage media. Cache 418 is a fast memory that enhances the performance of processor(s) 404 by holding recently accessed data, and near recently accessed data, from RAM 416.

Program instructions for migration program 112 may be stored in the persistent storage 408, or more generally, any computer readable storage media, for execution by one or more of the respective computer processors 404 via one or more memories of the memory 406. The persistent storage 408 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

The communications unit 412, in these examples, provides for communications with other data processing systems or devices. In these examples, the communications unit 412 includes one or more network interface cards. The communications unit 412 may provide communications through the use of either or both physical and wireless communications links. In the context of some embodiments of the present invention, the source of the various input data may be physically remote to the computer 400 such that the input data may be received, and the output similarly transmitted via the communications unit 412.

The I/O interface(s) 414 allows for input and output of data with other devices that may be connected to computer 400. For example, the I/O interface(s) 414 may provide a connection to external device(s) 420 such as a keyboard, a keypad, a touch screen, a microphone, a digital camera, and/or some other suitable input device. External device(s) 420 can also include portable computer readable storage media such as, for example, thumb drives, portable optical or magnetic disks, and memory cards. Software and data used to practice embodiments of the present invention, e.g., migration program 112, can be stored on such portable computer readable storage media and can be loaded onto persistent storage 408 via the I/O interface(s) 414. I/O interface(s) 414 also connect to a display 422.

Display 422 provides a mechanism to display data to a user and may be, for example, a computer monitor. Display 422 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for seamlessly migrating database systems, the computer-implemented method comprising:
responsive to receiving a data migration request, migrating, by one or more computer processors, a source data and a source index from a source cluster to a target cluster;
responsive to receiving a new data from a client to write to the source data during the data migration request, storing, by one or more computer processors, a delta data and a delta index in a portable data storage, wherein the delta data is the new data from the client to be written to the source data, and also wherein the delta index is created from the delta data; and
responsive to completing the data migration from the source cluster to the target cluster, migrating, by one or more computer processors, the delta data and the delta index from the portable data storage to the target cluster.

2. The computer-implemented method of claim 1, further comprising, responsive to the client initiating a read request during the data migration, combining, by one or more computer processors, the source data and the delta data to return a latest data to the client.

3. The computer-implemented method of claim 1, wherein migrating, by one or more computer processors, the source data and the source index from the source cluster to the target cluster further comprises:
creating, by one or more computer processors, one or more indices of the database system, wherein the one or more indices are created from the source index and the delta index; and
migrating, by one or more computer processors, the one or more indices of the database system to the target cluster.

4. The computer-implemented method of claim 1, further comprising initializing, by one or more computer processors, the target cluster, wherein initializing the target cluster includes mapping a configuration from the source cluster to the target cluster.

5. The computer-implemented method of claim 1, further comprising creating, by one or more computer processors, a data migration layer, wherein the data migration layer contains, at least, the portable data storage.

6. The computer-implemented method of claim 1, wherein the source cluster is composed of one or more shards.

7. The computer-implemented method of claim 1, wherein the data migration is performed shard by shard from the source cluster to the target cluster.

8. A computer program product for seamlessly migrating database systems, the computer program product comprising:
one or more computer readable storage devices and program instructions stored on the one or more computer readable storage devices, the stored program instructions comprising:
responsive to receiving a data migration request, program instructions to migrate a source data and a source index from a source cluster to a target cluster;
responsive to receiving a new data from a client to write to the source data during the data migration request, program instructions to store a delta data and a delta index in a portable data storage, wherein the delta data is the new data from the client to be written to the source data, and also wherein the delta index is created from the delta data; and
responsive to completing the data migration from the source cluster to the target cluster, program instructions to migrate the delta data and the delta index from the portable data storage to the target cluster.

9. The computer program product of claim 8, further comprising, responsive to the client initiating a read request during the data migration, program instructions to combine the source data and the delta data to return a latest data to the client.

10. The computer program product of claim 8, wherein program instructions to migrate the source data and the source index from the source cluster to the target cluster further comprises:
program instructions to create one or more indices of the database system, wherein the one or more indices are created from the source index and the delta index; and
program instructions to migrate the one or more indices of the database system to the target cluster.

11. The computer program product of claim 8, further comprising program instructions to initialize the target cluster, wherein initializing the target cluster includes mapping a configuration from the source cluster to the target cluster.

12. The computer program product of claim 8, further comprising program instructions to create a data migration layer, wherein the data migration layer contains, at least, the portable data storage.

13. The computer program product of claim 8, wherein the source cluster is composed of one or more shards.

14. The computer program product of claim 8, wherein the data migration is performed shard by shard from the source cluster to the target cluster.

15. A computer system for seamlessly migrating database systems, the computer program product comprising:
one or more computer processors;
one or more computer readable storage media; and
program instructions stored on the one or more computer readable storage media for execution by at least one of the one or more computer processors, the stored program instructions comprising:
responsive to receiving a data migration request, program instructions to migrate a source data and a source index from a source cluster to a target cluster;
responsive to receiving a new data from a client to write to the source data during the data migration request, program instructions to store a delta data and a delta index in a portable data storage, wherein the delta data is the new data from the client to be written to the source data, and also wherein the delta index is created from the delta data; and
responsive to completing the data migration from the source cluster to the target cluster, program instructions to migrate the delta data and the delta index from the portable data storage to the target cluster.

16. The computer system of claim 15, further comprising, responsive to the client initiating a read request during the data migration, program instructions to combine the source data and the delta data to return a latest data to the client.

17. The computer system of claim 15, wherein program instructions to migrate the source data and the source index from the source cluster to the target cluster further comprises:
program instructions to create one or more indices of the database system, wherein the one or more indices are created from the source index and the delta index; and
program instructions to migrate the one or more indices of the database system to the target cluster.

18. The computer system of claim 15, further comprising program instructions to initialize the target cluster, wherein initializing the target cluster includes mapping a configuration from the source cluster to the target cluster.

19. The computer system of claim 15, further comprising program instructions to create a data migration layer, wherein the data migration layer contains, at least, the portable data storage.

20. The computer system of claim 15, wherein the source cluster is composed of one or more shards.
